(19) United States
(12) Patent Application Publication
(10) Pub. No.: US 2021/0222459 A1
(43) Pub. Date: Jul. 22, 2021

(54) DOOR-LOCKING DEVICE TO LOCK THE DOOR OF A HOUSEHOLD APPLIANCE

(71) Applicant: BITRON S.p.A., Torino (IT)

(72) Inventor: Fabrizio PROMUTICO, Torino (IT)

(21) Appl. No.: 17/149,580

(22) Filed: Jan. 14, 2021

(30) Foreign Application Priority Data
Jan. 20, 2020 (IT) 102020000000940

(51) Int. Cl. E05B 47/00; E05B 55/00; F16H 1/16; D06F 39/14; D06F 58/20; D06F 37/42

(52) U.S. Cl. CPC E05B 47/0012; E05B 55/00; F16H 1/16; E05B 2047/0069; D06F 58/20; D06F 37/42; E05B 2047/0068; D06F 39/14

(57) ABSTRACT

A door-locking device for locking the door of a household appliance with a nose having a locking assembly that has a locking slider movable between an unlocked position and a locking position, in which, when said door is closed, said locking slider is engaged with said nose keeping said door in said the closed position, and an actuation unit, comprising in its turn an actuator, configured to move said locking slider from said unlocking position to said locking position and vice versa. Said locking assembly having a pin and said locking slider is movable with respect to said pin. Said locking slider has a guide path, to which said pin is constrained, and said actuator is movable with respect to said locking slider to interfere with said locking slider, causing the movement of said locking slider from said unlocking position to said locking position block and vice versa.

### INCORPORATION BY REFERENCE TO ANY PRIORITY APPLICATIONS

Any and all applications for which a foreign or domestic priority claim is identified in the Application Data Sheet as filed with the present application are incorporated by reference under 37 CFR 1.57 and made a part of this specification.

### BACKGROUND

### Field

The present invention relates to a door-locking device for locking the door of a household appliance.

In particular, the invention relates to a door-locking device intended to move a locking slider or a locking member between an unlocked position, and a locked position, in which said locking slider is engaged with a door nose of said household appliance, and vice versa, with electric control.

In the following the description will be directed to the application to a household appliance, such as a washing machine or a dryer or the like, but it is clear that it must not be considered limited to this specific use.

### Description of Related Art

As is well known, there are different types of door-locking devices for locking the door of a household appliance.

In general, said door-locking devices are equipped with sensors to detect if the door of the household appliance is open or closed.

The detection of the opening/closing of the door of the household appliance is required or in order to avoid, in case of malfunctions, that the household appliance may be activated when the door is opened.

Furthermore, said door-locking devices have rotating hooks capable of engaging with a nose of the door, a locking pin, capable of assuming a retracted position, in which it does not allow the activation of the household appliance, and an extracted position, in which it allows the operation start of the household appliance, a slider movable between a rest position, in which it prevents said pin to move from said retracted position to said extracted position, and an operative position, which is reached when said rotating hook engages with the nose of the door, allowing said pin to move from said retracted position to said extracted position.

A limitation of known door-locking devices is that, in case of the drum of a washing machine, for example, were full, the locking pin would be subjected to a stress by means of the slider. This could cause the blocking of the pin and therefore not to allow or block the correct operation of the washing machine.

In order to overcome the drawback indicated above, the known door-locking devices are equipped with systems capable of forcing the opening of the door of the household appliance by means of levers.

However, operating levers is inconvenient and, in any case, it would be desirable to limit the use of these levers.

### SUMMARY

Scope of the present invention is that of overcoming the drawbacks of the devices of the prior art, proposing a door-locking device for guiding the movement of a locking member capable of allowing unlocking the door even in the case of the drum of a household appliance is subjected to high mechanical stress from the inside.

A further scope of the invention is to propose a door-locking device that is resistant to water and steam infiltrations.

It is a specific object of the present invention a door-locking device for an electric household appliance, said household appliance being of the type comprising a door provided with a nose, said door-locking device comprising:
a locking assembly, comprising a locking slider movable between an unlocked position and a locking position, in which, said locking slider is configured to be engaged with said nose, so that, when said door is closed, said locking slider keeps said door in the closed position,
an actuation unit comprising an actuator, configured to move said locking slider from said unlocking position to said locking position and vice versa.

Said locking assembly comprises a pin and said locking slider is movable with respect to said pin, and said locking slider has a guide path, to which said pin is constrained.

Said actuator is movable with respect to said locking slider to interfere with said locking slider, causing the movement of said locking slider from said unlocking position to said locking position block and vice versa.

According to the invention, said actuator may be a toothed wheel (33) configured to rotate around an axis passing through the center of said toothed wheel, and a relief is arranged on said toothed wheel, so that when said toothed wheel rotates, said relief rotates and interferes with said locking slider.

In particular, said locking slider may be movable along a first plane and said toothed wheel rotates on a second plane, perpendicular to said first plane.

Further, said guide path may have a first end, a second end, a third end and a fourth end, wherein said ends are arranged in such a way as to be at the vertices of a geometric figure having substantially the shape of a heart and said locking assembly may be configured in such a way that said pin contacts and moves away successively from each of said ends of said guide path during the movement of said locking slider.

Said locking assembly may comprise a thrust spring, arranged in such a way that when said locking slider is in unlocked position, said thrust spring is compressed, and when said locking slider is in locked position, said thrust spring exerts a force on said locking slider.

The door-locking device may comprise:
an electric motor for rotating said toothed wheel,
a worm screw, connected to said motor and engaged with said toothed wheel, and
a logic control unit, connected to said electric motor, configured to selectively turn on and off said electric motor.

Advantageously, said door-locking device may comprise a containment casing provided with an opening shaped to receive said nose, when the door is closed, and it may comprise:
first detection means, connected to said logic control unit and configured to:
detect the position of said locking slider with respect to the nose of said door, and
send a signal to said logic control unit containing the information of the position of said locking slider,
   second detection means, connected to said logic control unit and configured to:
detect the position of the nose with respect to said opening, and
send a signal to said logic control unit containing the information of the position of said nose. Said logic control unit may be configured to:
   receive signals from said first detection means and from said second detection means,
   determine if the door is closed or if the door is closed and locked by said locking slider,
   turn off said electric motor when said logic control unit receives a signal from said first detection means and the locking slider is in the locked position.

In particular, said containment casing may be provided with a first seat in which a first magnet is housed and said locking unit is provided with a second seat in which said first detection means are housed.

Said first detection means may be configured to send a signal to said logic control unit when said first detection means are in correspondence or in proximity with said first magnet.

Said containment casing may be provided with a third seat in which said second detection means are housed, in which said third seat is arranged in correspondence or in proximity of said opening.

Said second detection means may be configured to send a signal to said logic control unit when the nose is inserted in said opening, and a second magnet, arranged inside said nose, is in correspondence or in proximity with said second detection means.

Advantageously, the door-locking device may comprise a valve to prevent steam from entering the door-locking device.

Further, a sealing rubber may be arranged around said electric motor.

### BRIEF DESCRIPTION OF THE DRAWINGS

The present invention will be now described, for illustrative but not limitative purposes, according to its preferred embodiments, with particular reference to the figures of the enclosed drawings, wherein:

FIG. 1 is a partially sectioned schematic view of a door-locking device, object of the invention, for locking the door of a household appliance;

FIG. 2 is a partial schematic view of the door-locking device according to the invention, illustrating the door of the household appliance in the closed position and locked by a locking slider of said door-locking device;

FIG. 3 is a partial schematic view of the door-locking device illustrating the locking slider in an unlocked position;

FIG. 4 is a partial schematic view of the door-locking device according to the invention, illustrating a relief that interferes with a projection of the locking slider;

FIG. 5 is a graph that illustrates the positions of the locking slider over the time, the states assumed by the first detection means of the door-locking device over the time, and the states assumed by the electric motor of the door-locking device over the time.

### DETAILED DESCRIPTION

In the various figures, similar parts will be indicated by the same reference numbers.

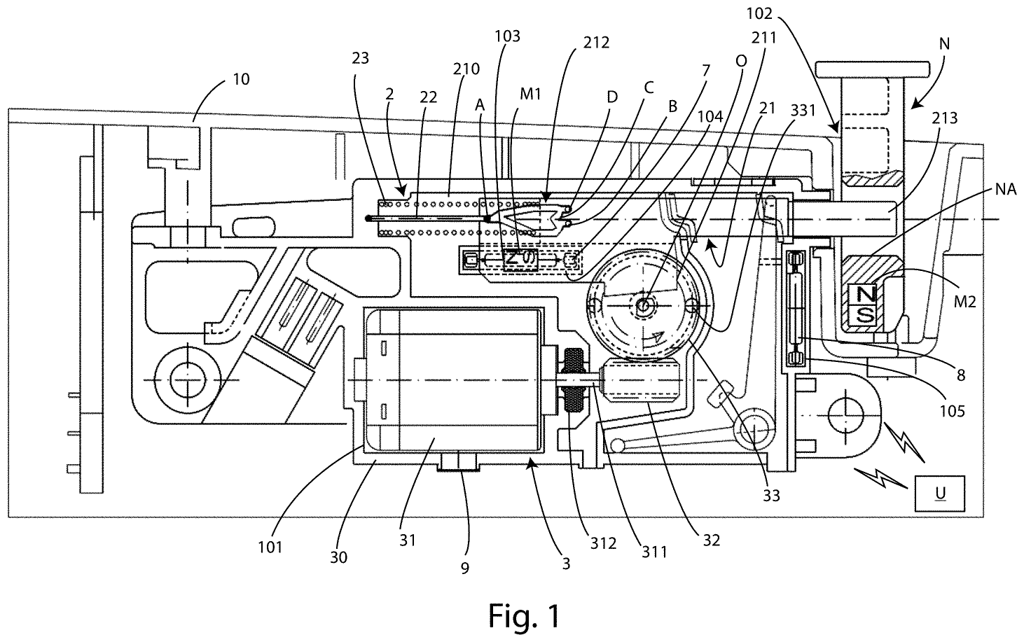

With particular reference to FIG. 1, a door-locking device 1 is described, according to the present invention, for locking the door of a household appliance (not shown in the figure), of which only the nose N is visible.

The door-locking device 1 comprises a containment casing 10, a locking assembly 2 for blocking said door, and an actuation unit 3.

In general, the containment casing 10 is made of plastic and is intended to contain the components of the door-locking device 1.

When the door-locking device 1 is installed on the household appliance, the containment casing 10 is fixed to the chassis of the household appliance itself.

The containment casing 10 has an opening 102, shaped to receive the nose N of the door, when the door is closed.

In addition, the containment casing 10 has a first seat 103, in which it is housed a first magnet M1, and said locking assembly 2 has a second seat 104, in which the first detection means 7 are housed.

In case of movement of the locking slider 21, said second seat 104 may be in correspondence, or in proximity of said first seat 103, and consequently said first detection means 7 may be located at or in proximity to said first magnet M1.

Furthermore, the containment casing 10 has a third seat 105, for housing second detection means 8.

Said third seat 105 is arranged in correspondence with, or in proximity of the opening 102 to receive the nose N.

The nose N is also equipped with a seat NA to house a second magnet M2.

When the nose N is inserted into the opening 102, the second magnet M2 inside said nose N is in correspondence with, or in proximity to said second detection means 8.

The operation of said detection means 7, 8, connected to a logic control unit U, and of said magnets M1, M2 will be described in detail in the following.

The locking assembly 2 comprises a locking slider 21, movable between a rest position or unlocked position, and an operative position or locked position, when the door of the household appliance is closed.

In particular, said locking slider 21 is configured to be engaged with the nose N of the door of the household appliance, so that, when said door is closed, said locking slider 21 keeps said door in a closed position.

More specifically, one end 213 of said locking slider 21 is configured to engage with said nose N.

The locking slider 21 is provided with a projection 211 that allows the locking slider interfering with a relief (as explained in the following).

Furthermore, said locking slider 21 has a guide path 212.

Said guide path 212 has the shape of a heart-shaped cam, i.e., a substantially heart-shaped cam.

Said guide path 212 has a first end A, a second end B, a third end C, and a fourth end D, and said ends are arranged in such a way as to be at the vertices of a geometric figure, which, as said, has substantially the shape of a heart.

With reference to the locking assembly, said locking assembly 2 comprises a pin 22, which, in the embodiment shown, is a metal rod. Said metal rod has a first end and a second end pivoted about said containment casing 10.

During the movement of the locking slider 21, the pin 22 contacts and moves away in sequence by each of said ends A, B, C, and D.

Hence the locking slider 21 is movable with respect to said pin 22.

In the embodiment described, the pin 22 will contact in sequence the first end A, the second end B, the third end C, and the fourth end D.

In other words, said pin 22 is a cam follower pin since the movement of said pin follows said guide path 212.

The stroke of said pin 22 is therefore constrained to the guide path 212 (in this case we can speak of a desmodromic system).

Advantageously, each position in which the pin 22 is in contact with a respective end of the guide path 212 is a stable position, and the locking slider 21 moves from its locking position, when the pin 22 contacts the first end A of the guide path 212, toward its release position, when the pin 22 contacts the fourth end D of the guide path 212, overcoming the resistance of a thrust spring 23 during its movement towards the position of release, as explained in detail below.

The locking assembly 2 comprises further a thrust spring 23, arranged in a cavity 210 of said containment casing 10, in such a way that, when said locking slider 21 is in the unlocked position, said thrust spring 23 is compressed, and that, when said locking slider 21 is in the locked position (i.e., engaged with the nose N of said door), said thrust spring 23 exerts a force on said locking slider 21.

The actuation unit 3 comprises:
an electric motor 31, housed in a housing 101 of said containment casing 10,
a crankshaft 311,
a worm screw 32 connected to said motor shaft 311.

In particular, said worm screw 32 is keyed on said shaft 311, the operation of which will be described below.

In addition, a gasket 312 is interposed between the crankshaft 311 and the containment casing 10, to protect the electric motor 31 from the moisture.

A logic control unit U provided in said door-locking device 1 is connected to said electric motor 31 and is configured to selectively operate said electric motor 31, i.e., to switch on and off said electric motor 31, so that an actuator 33 is set in motion or its movement is stopped.

The actuator unit 3 comprises in fact an actuator 33, movable relative to said locking slider 21 to interfere with said locking slider 21.

In the embodiment that is described, said actuator 33 comprises, or is constituted by a toothed wheel, configured to rotate around its own rotation axis (i.e., an axis passing through the center O of the tooted wheel itself), on which a relief 331 is arranged.

In particular, said relief 331 is arranged on a surface of said toothed wheel.

However, it is not necessary that the actuator 33 be of the rotatable type (such as the toothed wheel), but said actuator 33 can be a linear type actuator, which interferes with said locking slider during its movement along an axis parallel to the axis, along which said locking slider 21 moves.

Furthermore, in the embodiment described, said toothed wheel is rotatably pivoted about said containment casing 10 and is engaged with said worm screw 32.

Compared to the locking slider 21, the toothed wheel 33 is arranged in a manner such that the relief 331 interferes with the projection 211 of the locking slider 21 (or, in general, with said locking slider 21), when the toothed wheel 33 is rotating by the electric motor 31.

The toothed wheel 33 is configured to rotate only in one direction.

In the embodiment described, the toothed wheel 33 rotates counterclockwise.

However, the toothed wheel 33 can rotate clockwise, without departing from the scope of the invention.

In the described embodiment, said locking slider 21 is movable along a first plane, and said toothed wheel 33 rotates on a second plane, perpendicular to said first plane.

As said, the door-locking device is equipped with first detection means 7, and second detection means 8, as well as with a logic control unit U, connected to said first detection means 7, to said second detection means 8, and to the electric motor 31 (as already described).

Said first detection means 7 are configured to detect the position of the locking slider 21 with respect to the nose N of the household appliance door (i.e., if said locking slider 21 is in the locked or unlocked position), and to send a signal to said logic control unit U, containing the information about the position of the locking slider 21.

Said first detection means 7 may be constituted by a Hall sensor capable of detecting the position of the locking slider 21 with respect to the nose N, by means of the first magnet M1, mentioned above, arranged in proximity, or in correspondence of said first detection means 7.

A signal is sent to said logic control unit U when said first detection means 7 are in correspondence with, or in proximity to said first magnet M1.

Said second detection means 8 are configured to detect the position of the nose N with respect to the opening 102 of the containment casing 10 (i.e., if said nose is inserted in said opening 102) and send a signal to said logic control unit U containing the nose N position information.

With reference to the operation of the door-locking device described in the following, the term “active” or “activation” and “deactivate” or “deactivation” will be used referring to said first detection means and to said second detection means to indicate respectively that said detection means send a signal to the logic control unit U, or do not send any signal.

Said second detection means 8 may be constituted by a Hall sensor capable of detecting the position of the nose N with respect to the opening 102 of the containment casing 10, by means of the second magnet M2, mentioned above, arranged within the nose itself.

A signal is sent to said logic control unit U when said nose N is inserted into opening 102 and said second magnet is arranged at or near said second detection means.

Said control logic unit U is configured for:
receiving signals from said first detection means 7, and from said second detection means 8,
determining if the door of the household appliance is closed or if the door of the household appliance is closed and locked by the locking slider 21,
turn off said electric motor 31 when it receives a signal from said first detection means 7 and the locking slider 21 is in the locked position (in order to avoid a possible collision between the relief 331 and the locking slider).

Advantageously, the door-locking device comprises a valve 9 to prevent steam from entering the door-locking device itself.

Furthermore, a sealing rubber 30 is arranged around the electric motor 31.

The door-locking device 1 operates as follows.

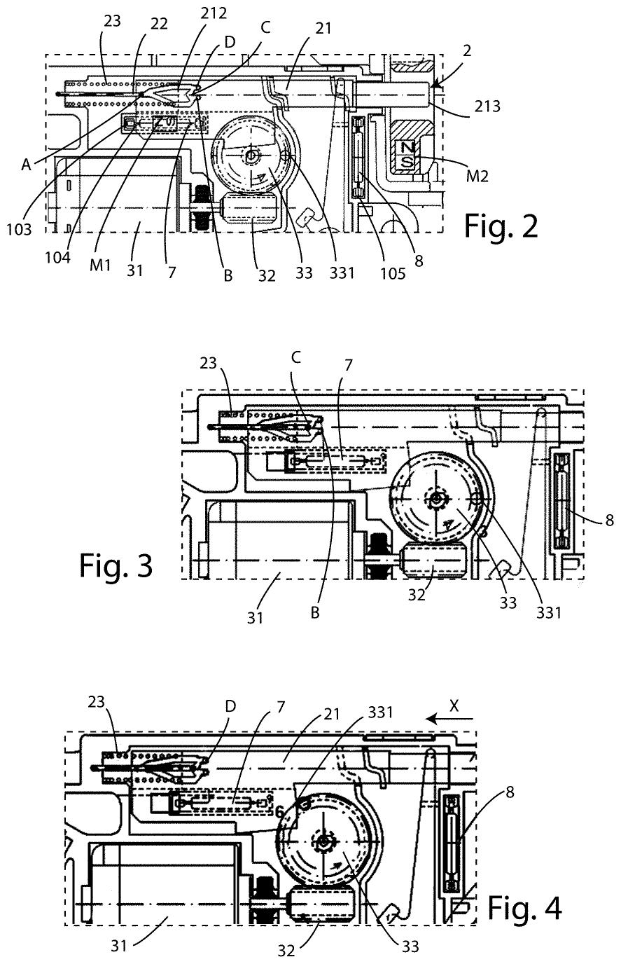

With reference to in FIG. 2, the door of the household appliance is in the closed position and is blocked by the locking slider 21.

In particular, the nose N is inserted in the opening 102 of the containment casing 10, and the end 213 of the locking slider 21 is engaged with said nose N.

Furthermore, said first detection means 7 and said second detection means 8 are active, being in proximity to the respective magnets M1 and M2, and send a respective signal to said logic control unit U to indicate that said door is closed and locked.

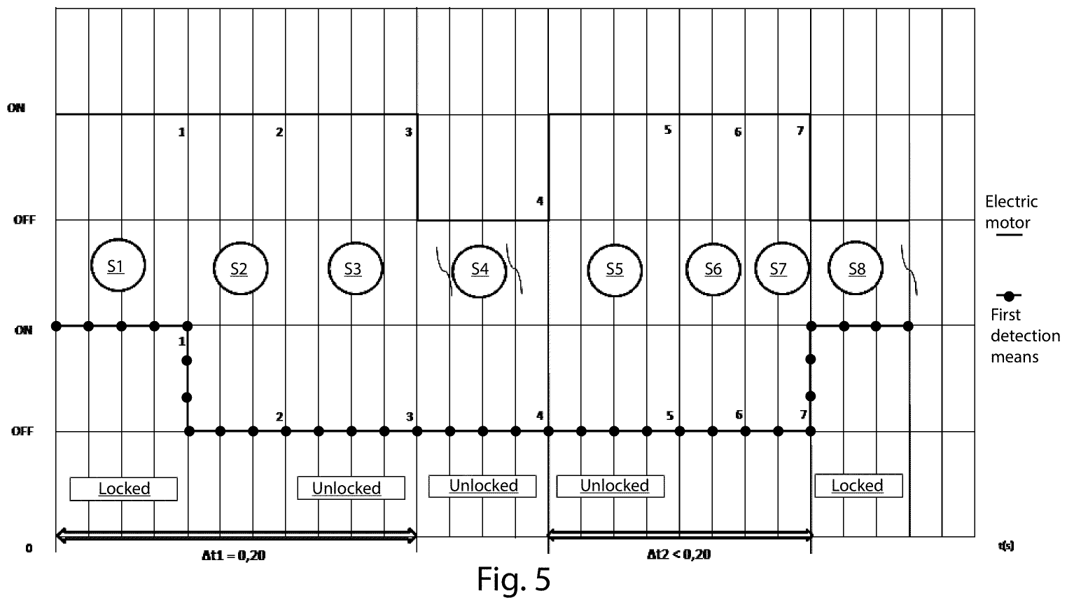

FIG. 5 shows the positions of the locking slider over time (i.e., position of unlocking indicated by the term “unlocked” or locked position indicated with the term “locked”), the activation and deactivation of said first detection means 7 respectively indicated by “ON” and “OFF” over time, and the states assumed by the electric motor 31 over time, indicated by the references S1-S8, relating to said electric motor when it is powered, indicated by the term “ON”, and when it is not powered, indicated with the term “OFF”. Furthermore, FIG. 5 shows that the electric motor 31 in the state prior to the first state indicated by S1 is not powered, and said first detection means 7 are active (ON).

The pin 22 contacts the first end A of said guide path 212, which is the end of the guide path 212 furthest apart from the end 213 of the locking slider 21 engaged with the nose N of the door of the household appliance.

Said blocking slider 21 is therefore in its blocking position.

When it is needed to unlock the door of the household appliance, i.e., to disengage the ends 213 of the locking slider 21 from the nose N of the door, the logic control unit U actuates the electric motor 31 to rotate the worm screw 32 and consequently the toothed wheel 33.

Following the rotation of the toothed wheel, the relief 331 interferes with the projection 211 of the locking slider 21, for moving said locking slider from the locked to the rest position, overcoming the resistance of the thrust spring 23.

At the same time, the pin 22 slides along the guide path 212, losing contact with the end A, and contacting the end B of said guide path 212.

Since the toothed wheel 33 continues to rotate, the relief 331 no longer interferes with the projection 211 of the locking slider 21.

Therefore, as a result of the thrust spring 23 action, the locking slider 21 moves toward its unlocked position, and the pin 22 loses contact with the end B and contact end C, as shown in FIG. 3.

With reference to FIG. 5, in a first time interval indicated as Δt₁=0.2 seconds, during which the electric motor 31 over the time assumes a first state S1, a second state S2, and a third state S3, the electric motor 31 is always powered (ON), while said first detection means 7 are active (ON) only when the electric motor 31 is in its first state S1 since said first detection means 7 are in correspondence with, or in proximity to the first magnet M1, and deactivated (OFF) when the electric motor 31 is in its second state S2 and in its third state S3 since said first detection means 7 are away from the first magnet M1.

The locking slider 21 is in the locked position when the electric motor is in its first state S1, and it is in the unlocked position when the electric motor 31 is in the states S2 and S3.

The locking slider 21 reaches its unlocked position, and the electric motor 31 is no longer activated by the control logic unit U since the latter interrupts the power supply of said electric motor.

In this case, the relief 331 is in any position.

As shown in FIG. 5, the electric motor 31 is in the state S4, i.e., said electric motor is turned off (OFF), and the locking slider 21 remains in its unlocked position.

In this way, the locking slider 21 is stably in its unlocked position, causing said first detection means 7 to move away from the first magnet M1.

Since the nose N of the door is still inserted in the opening 102 of the containment casing 10, the control logic unit U (connected to said first detection means 7 and to said second detection means 8) is able to determine that the door is no longer locked but is only in the closed position.

When the door is open, the nose N is extracted from the opening 102 and the second magnet M2 moves away from said second detection means 8.

At this point, the logic control unit U is able to detect that the door is no longer locked and is also open.

If the door of the household appliance is closed again, and consequently the nose N is inserted into said opening 102, the second magnet M2 (arranged inside the nose itself) approaches said second detection means 8 of the door-locking device, and the logic control unit U detects that the door is closed.

To lock the nose again, the control logic unit U operates the electric motor 31.

Consequently, the toothed wheel 33 is set in rotation, and the relief 331 rotates with it and interferes again with the projection 211 of the locking slider 21, as shown in FIG. 4.

The locking slider 21 again overcomes the resistance of the thrust spring 23, and the locking slider 21 moves in a direction X, so that the pin 22 loses contact with the end C, and contacts the end D of the guide path 212.

Continuing rotating together with the toothed wheel 33, the relief 331 no longer interferes with the projection 211 of the locking slider 21.

In this way, the pin 22 is free to move, thanks to the action of said thrust spring 23, from the end D of the guide path 212 to the end A.

Accordingly, the locking slider 21 moves from the unlocked position to the locked position, in which it is again engaged with the nose N.

At the same time, the logic control unit U interrupts the power supply of the electric motor 31, so that the relief 331 is in any position.

Said first detection means 7 are positioned again in correspondence with the first magnet M1, and send a signal to said control logic unit U, in such a way that the latter detects that the door is closed and locked so that the household appliance can be activated.

As shown in FIG. 5, in a second time interval indicated as Δtₜ<0.20 seconds, during which the electric motor 31 assumes in time a fifth state S5, a sixth state S6, and a seventh state S7, the electric motor 31 is always powered (ON), and said first detection means 7 are deactivated (OFF), until, once the locking slider 21 engages with the nose N of the door, said first detection means 7 detect the presence of the first magnet M1 and become activated (ON), while the electric motor assumes an eighth state S8, in which it is turned off.

As can be seen, the locking or the unlocking of the nose N by means of the locking slider 21 occurs without mechanical member or elements are subjected to mechanical stress, in case of the opening of the door is forced from the outside or from the inside, for example, because of a drum containing an excessive amount of cloths.

An advantage of the door-locking device, object of the present invention, is that the electric motor is always driven with the same polarity since the passage of the locking slider from its unlocked position to its locked position takes place thanks to the rotation of a toothed wheel, which always rotates in the same direction.

A further advantage is due to the fact that said door-locking device does not provide for mechanical member or elements that are subjected to mechanical stress in case the opening of the door is forced.

The present invention has been described for illustrative but not limitative purposes, according to its preferred embodiments, but it is to be understood that modifications and/or changes can be introduced by those skilled in the art without departing from the relevant scope as defined in the enclosed claims.

1. Door-locking device for an electric household appliance, said household appliance comprising a door provided with a nose, said door-locking device comprising:
a locking assembly, comprising a locking slider movable between an unlocked position and a locking position, wherein said locking slider is configured to be engaged with said nose, so that, when said door is closed, said locking slider keeps said door in the closed position,
an actuation unit comprising an actuator, configured to move said locking slider from said unlocking position to said locking position and vice versa,
wherein said locking assembly comprises a pin and said locking slider is movable with respect to said pin,
wherein said locking slider has a guide path, to which said pin is constrained,
wherein said actuator is movable with respect to said locking slider to interfere with said locking slider, causing the movement of said locking slider from said unlocking position to said locking position block and vice versa,
wherein said actuator is a toothed wheel configured to rotate around an axis passing through the center of said toothed wheel, and
a relief is arranged on said toothed wheel so that when said toothed wheel rotates, said relief rotates and interferes with said locking slider.

2. Door-locking device according claim 1, wherein said locking slider is movable along a first plane and said toothed wheel rotates on a second plane, perpendicular to said first plane.

3. Door-locking device according to claim 1, wherein said guide path has a first end, a second end, a third end and a fourth end, wherein said ends are arranged in such a way as to be at the vertices of a geometric figure having substantially the shape of a heart, and wherein said locking assembly is configured in such a way that said pin contacts and moves away successively from each of said ends of said guide path during the movement of said locking slider.

4. Door-locking device according to claim 1, wherein said locking assembly comprises a thrust spring, arranged in such a way that when said locking slider is in unlocked position, said thrust spring is compressed, and when said locking slider is in locked position, said thrust spring exerts a force on said locking slider.

5. Door-locking device according to claim 1, wherein said door-locking device comprises:
an electric motor for rotating said toothed wheel,
a worm screw, connected to said motor and engaged with said toothed wheel, and
a logic control unit, connected to said electric motor, configured to selectively turn on and off said electric motor.

6. Door-locking device according claim 5, wherein said door-locking device comprises a containment casing provided with an opening shaped to receive said nose, when the door is closed, in that said door-locking device comprises:
first detection means, connected to said logic control unit and configured to detect the position of said locking slider with respect to the nose of said door, and send a signal to said logic control unit containing the information of the position of said locking slider,
second detection means connected to said logic control unit and configured to detect the position of the nose with respect to said opening, and send a signal to said logic control unit containing the information of the position of said nose,
where wherein said logic control unit is configured to receive signals from said first detection means and from said second detection means, determine if the door is closed or if the door is closed and locked by said locking slider, and turn off said electric motor when said logic control unit receives a signal from said first detection means and the locking slider is in the locked position.

7. Door-locking device according to claim 6, wherein:
said containment casing is provided with a first seat in which a first magnet is housed and said locking unit is provided with a second seat in which said first detection means are housed, and
said first detection means are configured to send a signal to said logic control unit when said first detection means are in correspondence or in proximity with said first magnet,
said containment casing is provided with a third seat in which said second detection means are housed, in which said third seat is arranged in correspondence or in proximity of said opening, and
said second detection means are configured to send a signal to said logic control unit when the nose is inserted in said opening, and a second magnet, arranged inside said nose, is in correspondence or in proximity with said second detection means.

8. Door-locking device according to claim 1, wherein said door-locking device comprises a valve to prevent steam from entering the door-locking device.

9. Door-locking device according to claim 5, wherein a sealing rubber is arranged around said electric motor.
